(19) United States
(12) Patent Application Publication
(10) Pub. No.: US 2004/0188401 A1
(43) Pub. Date: Sep. 30, 2004

(54) LASER PROCESSING APPARATUS

(76) Inventors: Sadao Mori, Tsuchiura-shi (JP); Hiroyuki Sugawara, Tsuchiura-shi (JP); Hiroshi Aoyama, Ebina-shi (JP)

Correspondence Address: CROWELL & MORING LLP, INTELLECTUAL PROPERTY GROUP, P.O. BOX 14300, WASHINGTON, DC, 20044-4300, US

(21) Appl. No.: 10/400,438

(22) Filed: Mar. 28, 2003

(51) Int. Cl. B23K 26/06

(52) U.S. Cl. 219/121.74

(57) ABSTRACT

A laser processing apparatus is capable of making an axis of a processed hole vertical and providing flexibility for a location of deflecting means by positioning a laser beam output from a laser oscillator at a designed deflection point of an fθ lens. An optical correction system is provided between a first mirror which is freely rotatable around an axis M, and a second mirror which is freely rotatable around an axis N, so that the laser beam deflected by the first mirror is applied to a center of the second mirror. The correction optical system comprises, for example, two convex lenses having a focal length of f1, the distance between centers of the convex lenses being set to 2f1. The distance between centers of the first and second mirrors is set to 4f1.

### BACKGROUND OF THE INVENTION

1. Field of the Invention

The present invention relates to a laser processing apparatus which performs processing by applying a laser beam output from a light source with a fixed optical axis to a predetermined position of an fθ lens by using two deflecting means, and then condensing the laser beam by means of the fθ lens.

2. Description of the Prior Art

In a laser processing apparatus for drilling a printed circuit board by using a laser beam and a laser processing apparatus for performing marking, a laser oscillator is generally fixed. Then, the laser beam output from the laser oscillator is applied to an fθ lens, deflected with two freely rotatable mirrors of which rotation axes are at rectangular directions, and focused onto a work to perform processing. Here, the fθ lens having a focal length f is designed in such a way that a light beam, which passes through a predetermined point on the central axis of the fθ lens (hereinafter referred to as “designed deflecting point”) and forms an angle 0 with respect to the central axis, is focused at a distance f×θ from the central axis of the fθ lens on a focal plane and the laser beam is incident onto the work at a right angle. Accordingly, it is possible to position the laser beam at an any position in the horizontal direction by selecting the angle θ with respect to the central axis of the laser beam at the designed deflecting point.

However, if the designed deflecting point is positioned, for example, on the reflecting surface of the mirror closer to the fθ lens, when the other mirror is rotated, the laser beam will not pass through the designed deflecting point. Thus, when drilling was performed with the surface of the work approximately aligned with the focal plane, the axis of the hole was tilted, which produces a difference in the positions between the front entrance of the hole and the back entrance of the hole in the printed circuit board (or the hole bottom). Further, when marking was performed, the focused point was deviated from the position set by the mirrors, which deteriorated the accuracy of processing.

Accordingly, JP-A-5-228673 discloses to provide a third mirror between the laser oscillator and the mirror closer to the laser oscillator, and to move the third mirror in the direction of the optical axis of the laser beam to control so that the center of the laser beam reflected by the mirror closer to the laser oscillator coincides with the center of the second mirror.

### BRIEF SUMMARY OF THE INVENTION

When the marking is performed, in other words, when the processing targets are continuous, the technology disclosed in the above-described JP-A-5-228673 allows the processing speed and the processing accuracy to be improved.

However, when a printed circuit board is perforated, the processing positions are discontiguous, and moreover it is necessary to process approximately 1000 holes per second. For this reason, the technology disclosed in the above JP-A-5-228673 has too slow a response to be adopted as an apparatus for processing approximately 1000 holes per second.

Further, in order to make the axis of the processed hole approach to vertical, the two deflecting means need to be brought close to each other, which limits the shape and the location of the deflecting means.

It is an object of the present invention to provide a laser processing apparatus capable of solving the above-described problems of the conventional technology, positioning a laser beam output from a laser oscillator at a designed deflecting point of the fθ lens, thereby making an axis of a processed hole vertical and providing flexibility for the location of the deflecting means.

In order to achieve the above-described object, the present invention provides a laser processing apparatus comprising a light source which outputs a laser beam, a first deflecting means provided on an optical path of the laser beam for deflecting the laser beam in a first direction, a second deflecting means for deflecting the laser beam deflected by the first deflecting means in a second direction, which rotating axis is rectangular to the axis of the first deflecting means, and an fθ lens which focuses the laser beam deflected by the first and second deflecting means, characterized in that a correction optical system which allows the laser beam deflected at the deflection center of the first deflecting means to enter the deflection center of the second deflecting means is provided between the first deflecting means and the second deflecting means.

In this case, when the correction optical system includes two convex lenses of the same focal length f, and the total distance between the principal points of the convex lenses is K, it is preferable the distance between the adjacent principal points of the two lenses is set to 2f and the distance between the center of the first deflecting means and the center of the second deflecting means is set to 4f + K.

With reference now to the attached drawings, embodiments of the present invention will be explained in detail below.

### BRIEF DESCRIPTION OF THE SEVERAL VIEWS OF THE DRAWINGS

FIG. 1 is a plan view of a laser processing apparatus according to a first embodiment of the invention;

FIG. 2 is a side view of the laser processing apparatus according to the first embodiment of the invention;

FIG. 3 is a plan view of main components of a laser processing apparatus according to a second embodiment of the invention; and

FIG. 4 is a view showing an optical correction system according to a third embodiment of the invention.

### DETAILED DESCRIPTION OF THE INVENTION

First Embodiment

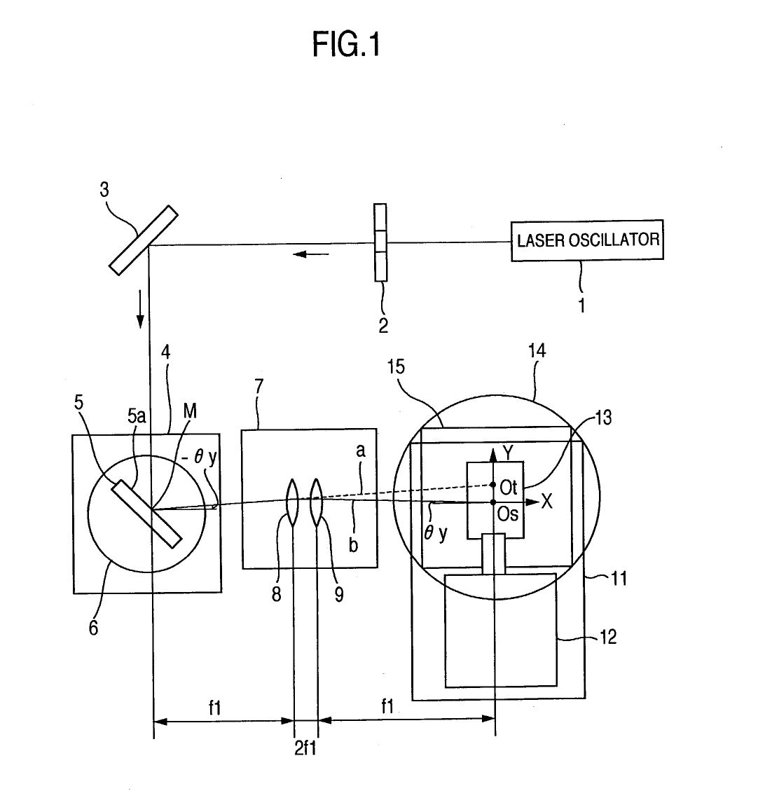

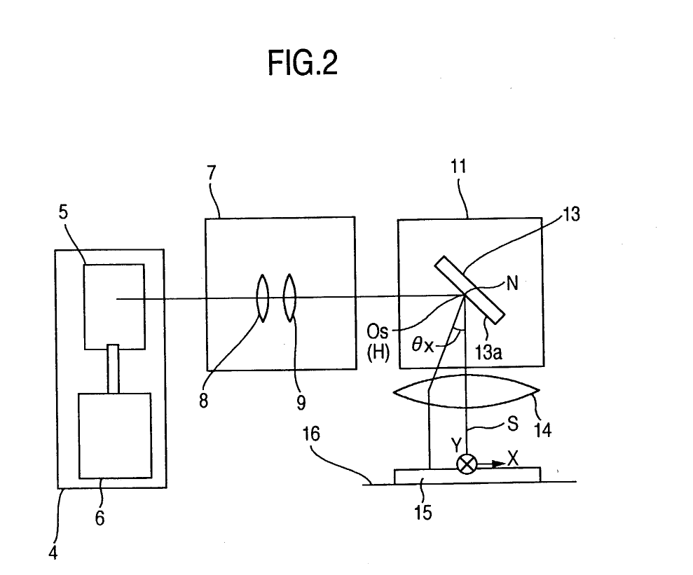

FIG. 1 is a plan view of a laser processing apparatus or according to a first embodiment of the invention, and FIG. 2 is a side view thereof.

On an optical path of a laser beam output from a laser oscillator 1, there are disposed an aperture 2, a fixed mirror 3, a first mirror 5 which constitutes a first deflecting means 4, an optical correction system 7, a second mirror 13 which constitutes a second deflecting means 11, and an fθ lens 14. The laser oscillator 1 outputs a laser beam in parallel to the sheet of FIG. 1.

The mirror 5 is supported by a motor 6, and can be freely positioned at any angles around an axis M perpendicular to the sheet of FIG. 1. The axis M is located on the reflecting surface 5a of the mirror 5. The mirror 5 is positioned so that the center of the reflecting surface 5a (which is a point on the axis M, and corresponds to the center in the transverse and longitudinal directions of the mirror 5) is placed at the center of the laser beam output from the laser oscillator 1.

The optical correction system 7 includes two convex lenses 8 and 9 which have the same focal length of f1 and spaced by twice the focal distance, 2f1, and the distance between the axis M and the convex lens 8, and the distance between the convex lens 9 and a rotation axis N of the mirror 13 are both f1.

Although a lens usually has two principal points, the explanations are made here on the assumption that the principal points are at the center of the lens.

The mirror 13 is supported on the rotation axis of a motor 12, and can be freely positioned at an any desired angle around the axis N which is parallel to the sheet of FIG. 1 (in other words, which is rectangular to the axis M). The axis N is on the reflecting surface 13a of the mirror 13.

The fθ lens 14 is positioned in such a way that the central axis S is perpendicular to an object 15 to be processed, and that the designed deflecting point H is located in the center Os of the reflecting surface 13a (which is a point on the axis N, and corresponds to the center in the transverse and longitudinal directions of the mirror 13).

The object 15 to be processed is fixed onto a table 16 with the center of a processing area aligned with the central axis S.

The operation of the laser processing apparatus according to the first embodiment in such a configuration will be described below.

A control apparatus (not shown) rotates the reflecting surface 5a from a reference angle to an angle −θy calculated from a Y-coordinate position of a processing portion described in a processing program, in which sign of the angle −θy is opposite to the sign of the Y-coordinate position, and rotates the reflecting surface 13a from a reference angle to an angle θx calculated from a X-coordinate position of the processing portion. Thereafter, the control apparatus operates the laser oscillator 1 to output the laser beam.

The outside shape of the laser beam emitted from the laser oscillator 1 is adjusted by the aperture 2, and enters the lens 8 deflected by the fixed mirror 3 and the reflecting surface 5a. The optical correction system 7 makes the laser beam deflected by the mirror 5 incident on the center of the mirror 13, and therefore the laser beam which goes out of the lens 9 passes along an optical path “b” expressed by a solid line in FIG. 1 and enters the center Os at an angle θy with an inverted sign. The laser beam is then reflected by the reflecting surface 13a, passes through the fθ lens 14, and is focused onto a surface of the object 15 to be processed (to form an image of the aperture 2) to process the object 15 to be processed.

Since the laser beam reflected by the reflecting surface 5a passes through the center Os, that is, passes through the designed deflecting point H, the laser beam is perpendicularly incident on a surface of the work 15 at an angle perpendicular to both the X-axis and the Y-axis. As a result, the axis of the processed hole becomes vertical.

As explained above, by providing the optical correction system 7 at a midpoint between the first and second deflecting means, the present invention can make the two deflecting points in the X-axis and the Y-axis equivalent, so that it becomes possible to increase flexibility in designing the apparatus.

In this embodiment, although the distance between the axis M and the convex lens 8 and the distance between the convex lens 9 and the rotation axis N of the mirror 13 are both set to f1, if the distance between the axis M and the axis N is set to 4f1, the optical correction system 7 may be located at an any position between the axis M and the axis N.

Further, the optical correction system 7 is not limited to the above-described configuration (afocal system), but may be any configuration as long as it makes the laser beam deflected by the mirror 5 incident on the central part of the mirror 13. If the optical correction system 7 is not provided, the laser beam passes through an optical path “a” and is incident on a point Ot which is out of the center Os, as shown by dotted lines in FIG. 1. As a result, the axis of the processed hole inclines in the Y-axis direction. Furthermore, since an incident position deviates from the center Os, it is required to increase the size of the mirror 13, which reduces response speed.

### Second Embodiment

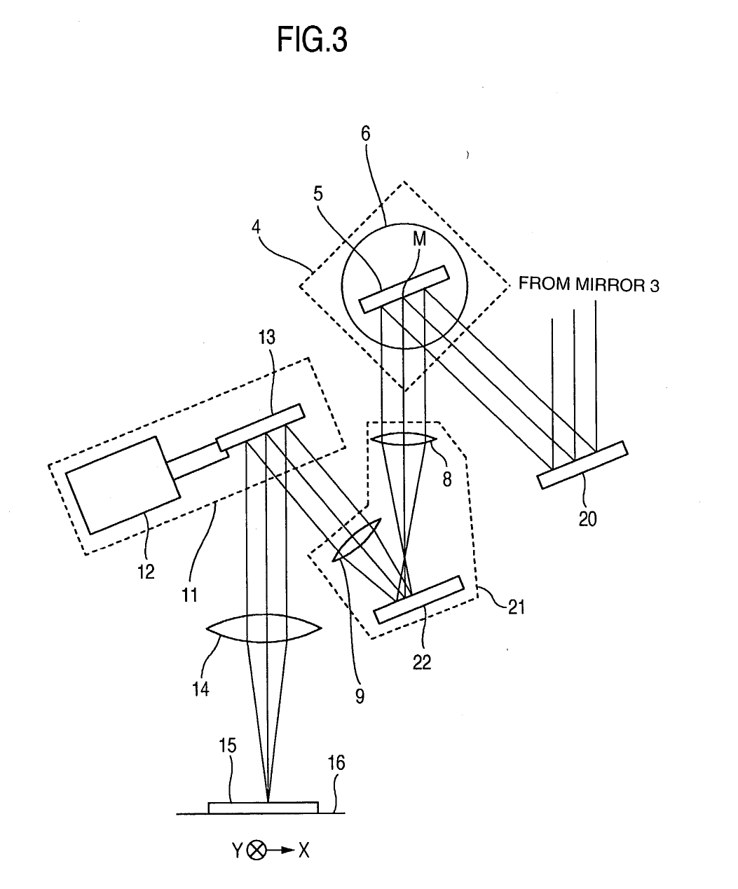

FIG. 3 is a side of main components of a laser processing apparatus according to a second embodiment of the present invention, and the same components or components having the same functions as those in FIG. 1 are denoted by the same reference numerals, so that explanations thereof will be omitted. The laser oscillator 1, aperture 2 and mirror 3 are omitted in the figure.

A mirror 20 reflects a laser beam reflected by the mirror 3 toward a mirror 5. The rotation axis M of the mirror 5 is perpendicular to the sheet of FIG. 3, and the direction of the rotation axis of a mirror 13 is inclined by an angle of 22.5 degrees from the direction parallel to the table 6 in the sheet.

A optical correction system 21 is constructed of lenses 8 and 9 and a mirror 22, in which the focal distances of the lenses 8 and 9 are both f1, and the focal distance of a lens 14 is F. The sum of the distance 11 from the center of the lens 8 to the center of the mirror 22 and distance 12 from the center of the lens 22 to the lens 9 (=11+12) is 2f1, and the distances 11 and 12 are set to different lengths. Further, the distance from the center of the mirror 5 to the center of the leans 8, the distance from the center of the lens 9 to the center of the mirror 13 and the distance from the center of the mirror 13 to the center of the fθ lens 14 are f1, respectively.

In the laser processing apparatus according to the second embodiment having the above-described configuration, the laser beam deflected by the mirror 5 is incident on the central part of the mirror 13 as in the case of the above-described first embodiment.

This second embodiment is effective in the case that the space for the optical correction system is limited, that is, in the case that the lens 8 and lens 9 cannot be placed on the same straight line. Further, as shown in the figure, if incident angles of the laser beam upon the mirrors 5 and 13 are reduced to an angle smaller than a general angle of 45 degrees (e.g., 22.5 degrees as shown in the figure), it is possible to make the sizes of the mirrors 5 and 13 smaller than those in the case that the incident angles are set to 45 degrees, so that the moment of inertia of the mirrors 5 and 13 can be reduced. As a result, it becomes possible to reduce the time necessary to position the mirrors 5 and 13, and thereby increase the processing speed compared to the above-described first embodiment.

Furthermore, since the distances 11 and 12 are set to different lengths, it is possible to prevent the surface of the mirror 22 from being damaged by heat.

In both the first and second embodiments described above, the optical correction system 7 makes the laser beam deflected by the mirror 5 incident on the central part of the mirror 13, and therefore it is possible to make the two deflecting points equivalent or almost equivalent with the designed deflecting points. As a result, the axis of the processed hole becomes vertical to improve the processing quality. Further, it is also possible to process a hole with a high aspect ratio. Furthermore, since no movable part for aligning the two deflecting points is provided, the processing speed does not decrease.

Although the above first and second deflecting means are provided by rotating mirrors, it is also possible to use other means such as an acoust-optical element.

Further, although the focal length of both lenses 8 and 9 are set to f1 in the above-described embodiment, both the focal distances may not be same, always.

Next, a more generalized case of the present invention will be explained.

### Third Embodiment

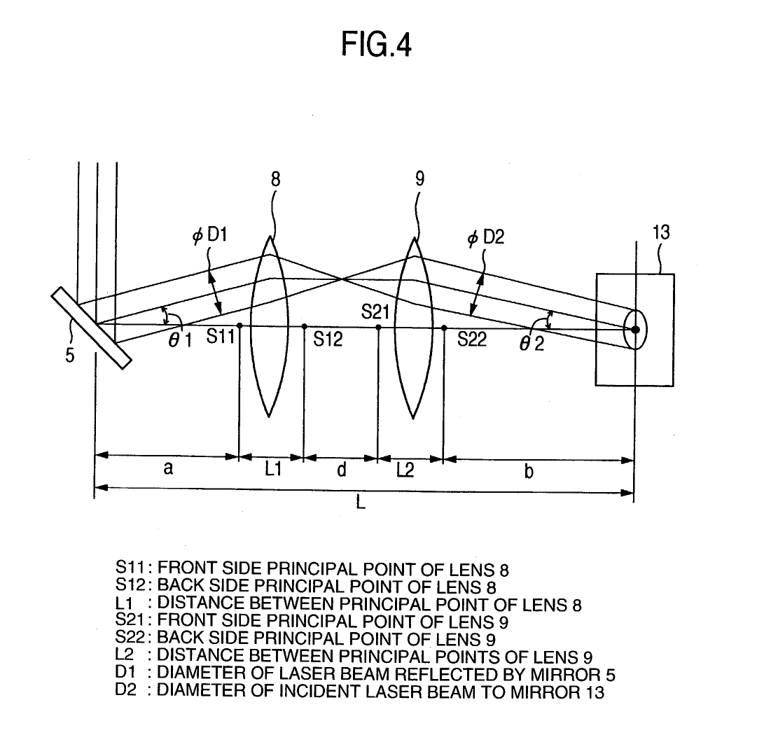

FIG. 4 illustrates an optical correction system according to a third embodiment of the present invention, and the same components or components having the same functions as those in FIG. 1 are denoted by the same reference numerals, thereby explanations thereof will be omitted. The laser oscillator 1, aperture 2, mirror 3 and the fθ lens 14 are omitted in the figure.

Reference characters in the figure are as follows:

S11: Front side principal point of lens 8;

S12: Back side principal point of lens 8;

S21: Front side principal point of lens 9;

S22: Back side principal point of lens 9;

D1: Diameter of aperture;

L1: Distance between principal points of lens 8;

L2: Distance between principal points of lens 9;

a: Distance from center of mirror 5 to front side principal point of lens 8;

b: Distance from back side principal point of lens 9 to center of mirror 13;

d: Distance from back side principal point of lens 8 to front side principal point of lens 9;

f1: Focal length of lens 8;

f2: Focal length of lens 9; and

L: Distance from center of mirror 5 to center of mirror 13.

Here, when assuming the focal length f1 and f2 are constants, there are a relationship among the distances a, b and d as expressed by formulas 1 and 2, a relationship between angles θ1 and θ2 expressed by formula 3, and a relationship between a diameter D1 of a laser beam reflected by the mirror 5 and a diameter D2 of a laser beam incident upon the mirror surface of the mirror 13 expressed by formula 4, as follows. In addition, a distance L from the center of the mirror 5 to the center of the mirror 13 is expressed by formula 5 as follows.

d f1+f2 Formula 1

$$\begin{matrix}\frac{b - f2}{a - f1} = - {( \frac{f2}{f1} )}^{2} & Formula 2 \\ θ 2 = - \frac{f1}{f2} θ 1 & Formula 3 \\ D2 = \frac{f2}{f1} D1 & Formula 4\end{matrix}$$

L=a+L1+d +L2+b Formula 5

As is apparent from formula 3, in the case of f1>f2, the absolute value of angle θ2 is greater than the absolute value of angle θ1. As a result, the rotation angle of the mirror 5 can be decreased, and therefore it is possible to perform high efficiency processing.

Further, in the case of f1<f2, the absolute value of angle θ2 is smaller than the absolute value of angle θ1. Thus, even if the error of the positioning angle of the mirror 5 is large, it is possible to achieve the high precision processing.

The lenses 8 and 9 are not limited to single lenses, but may also be a combined lens composed of a plurality of lenses used for correcting lens aberration to reduce distortion of the laser beam. Even if the combined lens is used, the above-described formulas 1 to 5 can be applied using a combined focal distance and principal point positions.

As described above, this embodiment provides the optical correction system 7 between the mirror 5 and the mirror 13, which are freely rotatable around their respective axes, to make a laser beam deflected with the mirror 5 incident on the center of the mirror 13, so that an axis of a hole to be processed is made vertical, thereby the processing quality is improved. It is also possible to process a hole with a high aspect ratio. The laser beam incident upon the mirror 5 is incident on the central part of the mirror 13 irrespective of the angle of the mirror 5, and therefore it is possible to reduce the size of the mirror 13. The absence of any movable part to make the two deflecting points equivalent can also improve the processing speed.

As described above, according to the present invention, there is provided an optical correction system between a first deflecting means and a second deflecting means to make a laser beam deflected at the deflection center of the first deflecting means incident on the deflection center of the second deflecting means, so that an axis of a hole to be processed becomes vertical and processing quality is improved. It is also possible to process a hole with a high aspect ratio.

Further, the laser beam incident upon the first deflecting means is incident on the central part of the second deflecting means irrespective of the angle of the first deflecting means, and therefore it is possible to reduce the size of the second deflecting means. The absence of any movable part to make the two deflecting points equivalent can also improve the processing speed.

What is claimed is:

1. A laser processing apparatus comprising:
a light source which outputs a laser beam;
a first deflecting means provided on an optical path of the laser beam, which first deflecting means deflects the laser beam in a first direction;
a second deflecting means which deflects the laser beam deflected by the first deflecting means in a second direction; and
an fθ lens which condenses the laser beam deflected by the first deflection means and the second deflecting means; wherein
the apparatus further comprises an optical correction system provided between the first deflection means and the second deflecting means, which system makes the laser beam deflected at a deflection center of the first deflecting means to proceed to a deflection center of the second deflecting means.

2. The laser processing apparatus according to claim 1, wherein the optical correction system comprises first and second convex lenses having the same focal length f, the total of the distance between principal points of the first convex lens and the distance between principal points of the second convex lens being K, the distance between the principal point of the first convex lens on a facing side to the second convex lens and the principal point of the second convex lens on a facing side to the first convex lens being 2f, the distance between the center of the first deflecting means and the center of the second deflecting means being 4f+ K.
